(19) United States
(12) Patent Application Publication
(10) Pub. No.: US 2008/0056758 A1
(43) Pub. Date: Mar. 6, 2008

(54) Image holding element cleaning apparatus and image forming apparatus

(75) Inventor: Shinichi Kawamata, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/882,696

(22) Filed: Aug. 3, 2007

(30) Foreign Application Priority Data
Aug. 31, 2006 (JP) P2006-236502

(51) Int. Cl. G03G 15/16

(52) U.S. Cl. 399/101

(57) ABSTRACT

An image holding element cleaning apparatus includes: an image holding element; an image holding element cleaning unit that touches and detaches from the image holding element and that cleans the image holding element when the image holding element cleaning unit touches the image holding element; a detection unit that detects at least one of a position of the image holding element cleaning unit on the image holding element when the image holding element cleaning unit touches the image holding element, and a position of the image holding element cleaning unit on the image holding element when the image holding element cleaning unit detaches from the image holding element; and an adjusting unit that adjusts at least one of an operation timing of touching and an operation timing of detaching based on a result of a detection by the detection unit, the operation timing of touching being the timing when the image holding element cleaning unit touches the image holding element, and the operation timing of detaching being the timing when the image holding element cleaning unit detaches from the image holding element.

### CROSS-REFERENCE TO RELATED APPLICATION

This application is based on and claims priority under 35 USC 119 from Japanese Patent Application No. 2006-236502 filed Aug. 31, 2006.

### BACKGROUND

### 1. Technical Field

The present invention relates to an image holding element cleaning apparatus and an image forming apparatus.

### SUMMARY

According to an aspect of the invention, there is provided an image holding element cleaning apparatus including: an image holding element; an image holding element cleaning unit that touches and detaches from the image holding element and that cleans the image holding element when the image holding element cleaning unit touches the image holding element; a detection unit that detects at least one of a position of the image holding element cleaning unit on the image holding element when the image holding element cleaning unit touches the image holding element, and a position of the image holding element cleaning unit on the image holding element when the image holding element cleaning unit detaches from the image holding element; and an adjusting unit that adjusts at least one of an operation timing of touching and an operation timing of detaching based on a result of a detection by the detection unit, the operation timing of touching being the timing when the image holding element cleaning unit touches the image holding element, and the operation timing of detaching being the timing when the image holding element cleaning unit detaches from the image holding element.

### BRIEF DESCRIPTION OF THE DRAWINGS

Embodiments of the present invention will be described in detail based on the following figures, wherein:

FIG. 1 illustrates a conceptual diagram which shows schematically an exemplary example of an image forming apparatus to which the invention is applied;

FIG. 2 illustrates a block diagram which schematically shows a control system;

FIG. 3 illustrates an enlarged view which schematically shows the periphery of a cleaning apparatus shown in FIG. 1;

FIG. 4 illustrates a diagram which shows a state in which a retraction line is produced;

FIG. 5 illustrates a diagram which shows a state in which a contact line is produced;

FIGS. 6A to 6E illustrate conceptual diagrams which show a position adjustment mode;

FIG. 7 illustrates a flowchart which shows an exemplary example of a processing procedure of the position adjustment mode; and

FIGS. 8A and 8B illustrate diagrams which show an exemplary example of an operation that is to be performed after contact and retraction positions of a blade have been adjusted; and

FIGS. 9A to 9C illustrate diagrams which explain the standard value of the invention.

### DETAILED DESCRIPTION

### (1) First Embodiment

### (Configuration)

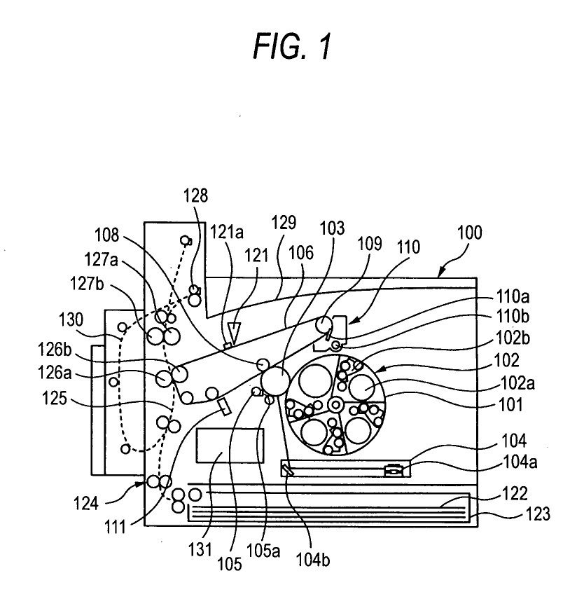

FIG. 1 is a conceptual diagram which shows schematically an example of an image forming apparatus which makes use of the invention. A color printer 100 is shown in FIG. 1 as an example of an image forming apparatus. The color printer 100 includes a single-drum type developing machine 101. The developing machine 101 includes four developing units 102 which correspond to primary colors of YMCK (Yellow, Magenta, Cyan, Black), respectively. Each developing unit 102 includes a toner bottle 102a and a toner supply mechanism 102b. Each toner bottle 102a holds any of YMCK toners which corresponds to the developing unit 102 which holds the relevant toner bottle 102a.

A light-sensitive material drum 103 is disposed in such a manner as to be in contact with the developing machine 101. The light-sensitive material drum 103 is partially exposed by a scanning light that is shone from an optical writing apparatus 104, whereby a latent image is formed on a surface thereof. The optical writing apparatus 104 (ROS) is an exposing scanner for writing and includes a laser emitting unit 104a and an optical system 104b which guides a laser beam. A latent image is formed on the surface of the light-sensitive material drum 103 by scanning light shone on to the light-sensitive material drum 103 from the optical writing apparatus 104 in association with the rotation of the light-sensitive material drum 103. The surface of the light-sensitive material drum 103 is charged in accordance with the latent image, and any of the YMCK toners is selectively supplied to the light-sensitive material drum 103 from one of the developing units 102 of the developing machine 101 by being attracted by an electric field generated in association with the charging. Thus, any of the YMCK toners is caused to adhere to the surface of the light-sensitive material drum 103 in accordance with the latent image which is formed by the optical writing apparatus 104 in the way described above, so as to form a toner image in accordance with the latent image.

A light-sensitive material drum cleaning apparatus 105 is provided in proximity to the light-sensitive material drum 103. The light-sensitive material drum cleaning apparatus 105 includes a function to move a light-sensitive material drum blade 105a into contact with the surface of the light-sensitive material drum 103 so as to scrape thereoff residual toner which remains on the surface of the light-sensitive material drum 103 by making use of the rotational force of the light-sensitive material drum 103. In addition, toner so scraped off is recovered by a toner recovery unit, not shown.

A transfer belt 106 is disposed in such a state that the belt is in contact with the light-sensitive material drum 103. In addition, a primary transfer roller 108 is disposed in a position which oppositely faces the light-sensitive material drum 103 across the transfer belt 106 in such a manner as to hold the transfer belt 106 between the light-sensitive material drum 103 and itself. A bias voltage, which is necessary when transferring a toner image, is made to be applied between the light-sensitive material drum 103 and the primary transfer roller 108. The transfer belt 106 is transferred by a drive roller 109 at a speed which is in synchronism with the rotation of the light-sensitive material drum 103. As this occurs, the transfer belt 106 comes to be held between the light-sensitive material drum 103 and the primary transfer roller 108, and a bias voltage is then applied between the light-sensitive material drum 103 and the primary transfer roller 108, whereby a primary transfer of a toner image is carried out from the light-sensitive material drum 103 to the transfer belt 106. As this occurs, in the case of a color image, a primary transfer is carried out four times so as to cover the four colors of YMCK, and images of four colors are superposed one on another, whereby a color toner image is formed on the transfer belt 106. On the other hand, in the case of a monochrome image, a transfer is carried out for one of the four colors of YMCK.

A toner sensor 111 is disposed in proximity to the transfer belt 106. The toner sensor 111 is an optical sensor and monitors optically the condition of toner that adheres to the transfer belt 106. Whether or not a toner image of a specified density is formed is determined from an output from the toner sensor 111. A mark detection sensor 121 is disposed in proximity to the transfer belt 106. A position detection mark 121a that is formed on the transfer belt 106 is detected by the mark detection sensor 121. This position detection mark 121a is made use of to determine a position where a primary transfer is carried out on to the transfer belt 106. In addition, the position detection mark 121a is also made use of as a mark for adjustment of the position of the blade 110a.

A sheet cassette which holds printing sheets 122 as recording materials is installed in a bottom portion of the color printer 100. Printing sheets 122 are transferred along a sheet transfer path 125 by a sheet transfer system which is represented by reference numeral 124. Secondary transfer rollers 126a and 126b, which are transfer members, are disposed in an intermediate position along the length of the sheet transfer path 125. A printing sheet, not shown, which has been transferred along the sheet transfer path 125 as far as the secondary transfer rollers 126a and 126b and the transfer belt are held between the secondary transfer rollers 126a and 126b, whereby the toner image now transferred on the surface of the transfer belt 106 is further secondarily transferred on to the printing sheet.

In secondarily transferring the toner image on to the printing sheet, the secondary transfer roller 126a is brought into contact with the transfer belt 106 when the toner image approaches the secondary transfer roller 126a. Here, “being brought into contact” means that a state is brought about in which the secondary transfer roller 126a is brought into contact with the transfer belt 106 so as to be in a position to assist in secondary transfer. Then, after the toner image has been secondarily transferred on to the printing sheet, the secondary transfer roller 126a is retracted from the transfer belt 106. Here, “being retracted” means that a state is brought about in which the secondary transfer roller 126a is moved apart or separated from the transfer belt 106. The reason the secondary transfer roller 126a is brought into contact with and retracted from the transfer belt 106 is to avoid a risk that toner on contact and retraction lines which are formed on the transfer belt 106 stick to the secondary transfer roller 126a to produce lines of toner dirt on a back of a printing sheet when a secondary transfer is carried out on the printing sheet. Note that the contact and retraction lines will be described later on.

The printing sheet on which the toner image is travels along the sheet transfer path 125 and is transferred between fixing rollers 127a and 127b. The fixing roller 127b incorporates therein a heater for heating a toner material making up the toner image on the printing sheet when the printing sheet is transferred in the manner described above. The toner is fixed by being so heated, and an image is formed on the printing sheet. The printing sheet, on which the fixing process has been so completed, is then discharged from a discharge mechanism 128 on to a discharge surface 129. Note that reference numeral 130 denotes a sheet transfer path for double-side printing.

A cleaning apparatus 110 is disposed in proximity to the transfer belt 106. A blade 110a, which is an image holding element cleaning unit, and a toner recovery unit 110b are disposed on the cleaning apparatus 110, whereby toner, which still remains on the transfer belt 106 without being secondarily transferred to the printing sheet, is scraped off by the blade 110a which is in contact with the transfer belt 106 and is then recovered into the toner recovery unit 110b. In addition, the details of the cleaning apparatus 110 will be described later on.

In scraping off toner which remains on the transfer belt 106, the blade 110a is brought into contact with the transfer belt 106 when the position on the transfer belt 106 where the toner image formed thereon was primarily transferred approaches the blade 110a. Here, “being brought into contact” means that a state is brought about in which the blade 110a is brought into contact with the transfer belt 106 so as to get ready for cleaning the transfer belt 106.

Then, when the position on the transfer belt 106 where the toner image formed thereon was primarily transferred has passed the blade 110a, the blade 110a is retracted from the transfer belt 106. Here, “being retracted” means that a state is brought about in which the blade 110a is moved apart or separated from the transfer belt 106. The reason the blade 110a is brought into contact with and retracted from the transfer belt 106 is to prevent toner images from being scraped off until images of four colors have been superposed one on another in the case of color printing in which a primary transfer is carried out four times to cover the four colors of YMCK so to primarily transfer images in four colors of YMCK on to the transfer belt 106 in a superposed fashion. Although the blade 110a produces contact and retraction lines when the blade 110a moves into contact with and apart from the transfer belt 106, the detailed background of production of the contact and retraction lines will be described later on.

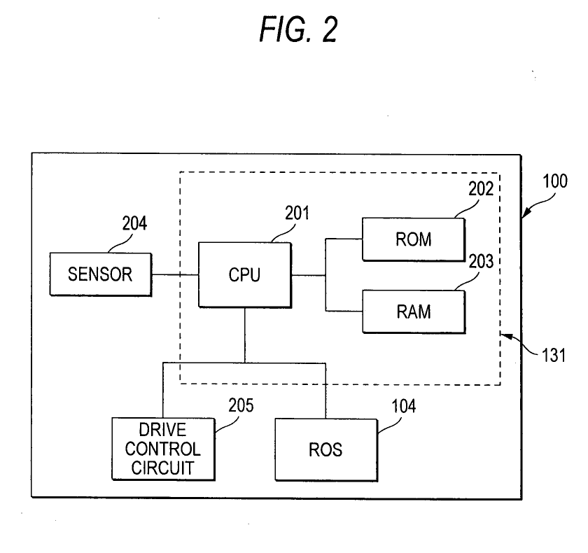

In FIG. 1, reference numeral 131 denotes a control unit that controls the operation of the color printer 100. FIG. 2 is a block diagram which shows schematically a control system which includes the control unit 131. The control unit 131 includes a CPU (central processing unit) 201, a ROM (read only memory) 202 and a RAM (random access memory) 203. The CPU 201 governs the operation of the whole control system shown in FIG. 2 and has a function to execute an operation procedure which will be described later on. The ROM 202 stores therein an operation program for executing the operation procedure which will be described later on and data which is necessary for the operation of the program. Values are contained in the data which will be utilized in the operation procedure which will be described later on.

In execution of the operation procedure which will be described later on, the RAM 203 functions as a working area which stores temporarily program data and various types of data and as a storage unit that stores various data that will be obtained in the operation procedure which will be described later on. A nonvolatile memory is also contained in the RAM 203, and necessary data is held even though a power supply is switched off. For example, data on contact and retracted positions of the blade 110a before the contact and retracted positions of the blade 110a are adjusted are stored in the RAM 203. A drive control circuit 205 is a circuit for controlling the developing machine 102, the light-sensitive material drum 103, the transfer belt 106, the cleaning apparatus 110, the fixing rollers 127a and 127b and a motor for driving the printing sheet transfer system 124.

A sensor 204 detects a rotational condition and a rotational angle of the motor which is driven by the drive control circuit 205, a transfer condition of printing sheets, an image forming number and an image forming quantity. The mark detection sensor 121 and the toner sensor 111 are also included in the sensor 204.

Thus, the example of the single-drum type image forming apparatus has been described which utilizes the developing unit into which the four colors of YMCK are incorporated and the single light-sensitive material drum. However, the invention can also be applied to an image forming apparatus which includes tow or more sets of developing units and light-sensitive material drums.

### (Operation Example)

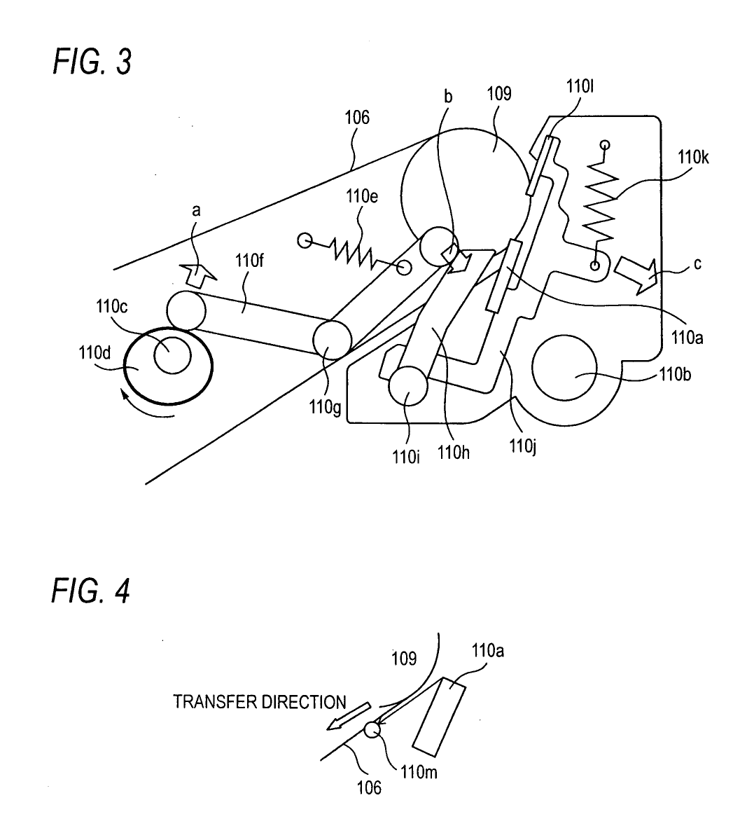

Firstly, an example of contact and retraction (separation) operations of the blade 110a will be described. FIG. 3 is an enlarged view schematically showing the periphery of the cleaning apparatus 110 shown in FIG. 1. The cleaning apparatus 110 is given power at a predetermined timing from a drive unit, not shown, by the drive control circuit 205 so as to perform contact and retraction operations of the blade 110a. To describe the retraction operation of the operations performed by the cleaning apparatus 110, the drive unit, not shown, transmits power to a cam shaft 110c, and a cam 110d rotates by virtue of rotation of the cam shaft 110c, whereby the power so transmitted is applied to a link arm 110f in a direction indicated by an arrow a by virtue of rotation of the cam 110d. Then, the link arm 110f, which is in contact with the cam 110d by virtue of an action of an arm spring 110e, rotates about a link arm rotational center shaft 110g by virtue of a rotational action of the cam 110d to transmit the power in a direction indicated by an arrow b, so that the power is then transmitted to a link arm facing member 110h. Here, while a component which produces a rotational driving force is illustrated as the drive unit, a component such as a solenoid which produces a linear driving force may be utilized as the drive unit.

The link arm facing member 110h, to which the power is so transmitted, is connected to a bracket rotational center shaft 110i, and furthermore, a bracket 110j is also connected to the bracket rotational center shaft 110i, whereby the power is then transmitted to the bracket 110j. Then, the bracket 110j retracts the blade 110a and a film seal 110l from the transfer belt 106 towards a direction indicated by an arrow c by virtue of the power which is so transmitted to the bracket 110j.

On the other hand, to describe the contact operation of the blade 110a, when power is transmitted further from the drive unit, not shown, to the cam shaft 110c, the blade 110a and the film seal 110l are brought into contact with the transfer belt by an action of a bracket spring 110k. The blade 110a, which is brought into contact with the transfer belt 106, scrapes off toner remaining on the transfer belt 106, and the toner so scraped off is then recovered by the toner recovery unit 110b. The film seal 110l, which is brought into contact with the transfer belt 106, prevents the toner scraped off by the blade 110a from scattering.

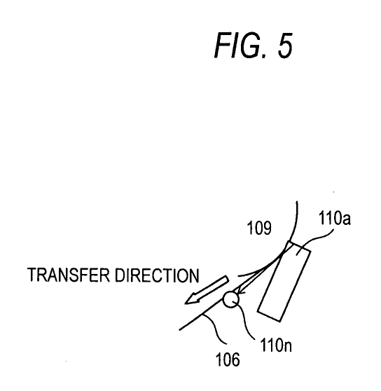

FIG. 4 is a diagram which shows a state a retraction line, which is produced when the blade 110a is retracted from the transfer belt 106 as shown in FIG. 3, is produced. FIG. 5 is a diagram which shows a state a contact line, which is produced when the blade 110a is brought into contact with the transfer belt 106 as shown in FIG. 3. Note that the transfer belt 106 is driven in a direction indicated by an arrow by the drive roller 109. Firstly, to describe the production of a retraction line, when the blade 110a, which is in contact with the transfer belt 106, scrapes off toner remaining on the transfer belt 106, part of the toner adheres to a distal end of the blade 110a. Then, in the event that the blade 110a is retracted with the toner so adhering thereto, dirt in the form of a line 110m is caused to adhere on to the transfer belt as soon as the blade 110a moves apart from the transfer belt 106.

Next, to describe the production of a contact line, when the distal end of the blade 110a is brought into contact with the transfer belt 106, the toner which adheres to the distal end of the blade 110a returns on to the transfer belt 106 as soon as the blade 110a is brought into contact with the transfer belt 106, whereby dirt in the form of a line 110n is caused to adhere on to the transfer belt 106.

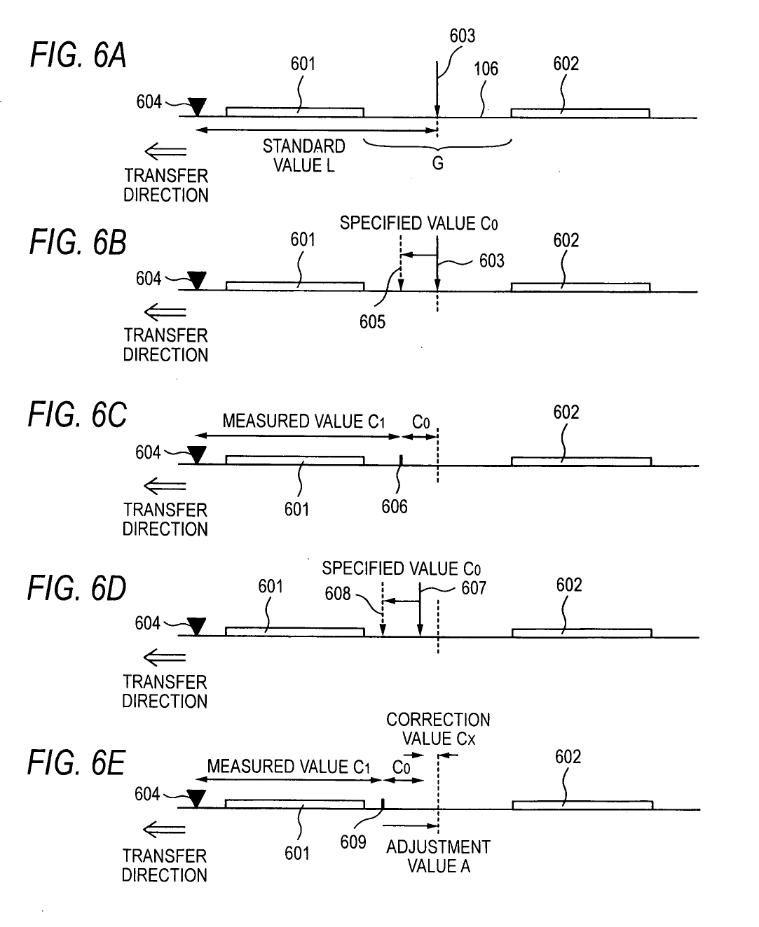

Next, an example of a method will be described in which the contact and retraction positions of the blade 110a are detected for adjustment. FIGS. 6A to 6E show conceptual diagrams of a position adjustment mode which illustrate an example of a method for adjusting the contact and retraction positions of the blade 110a. Here, the “position adjustment mode” is a mode in which the contact and retraction positions of the blade 110a are shifted by a specified value so as to adjust the contact and retraction positions of the blade 110a. In addition, note that shifting the contact and retraction positions of the blade 110a by the specified value is to measure a deviation between the contact and retraction positions.

FIG. 6A shows a case where the transfer belt 106 is transferred in a direction indicated by an arrow by the drive roller 109 with halftones 601 and 602 of an image formed on the transfer belt 106 and the blade 110a is adjusted to an ideal contact position 603 and retraction position 603 in a non-image area G. The ideal contact position 603 and retraction position 603 lie in a position which is apart from a home position by a standard value L.

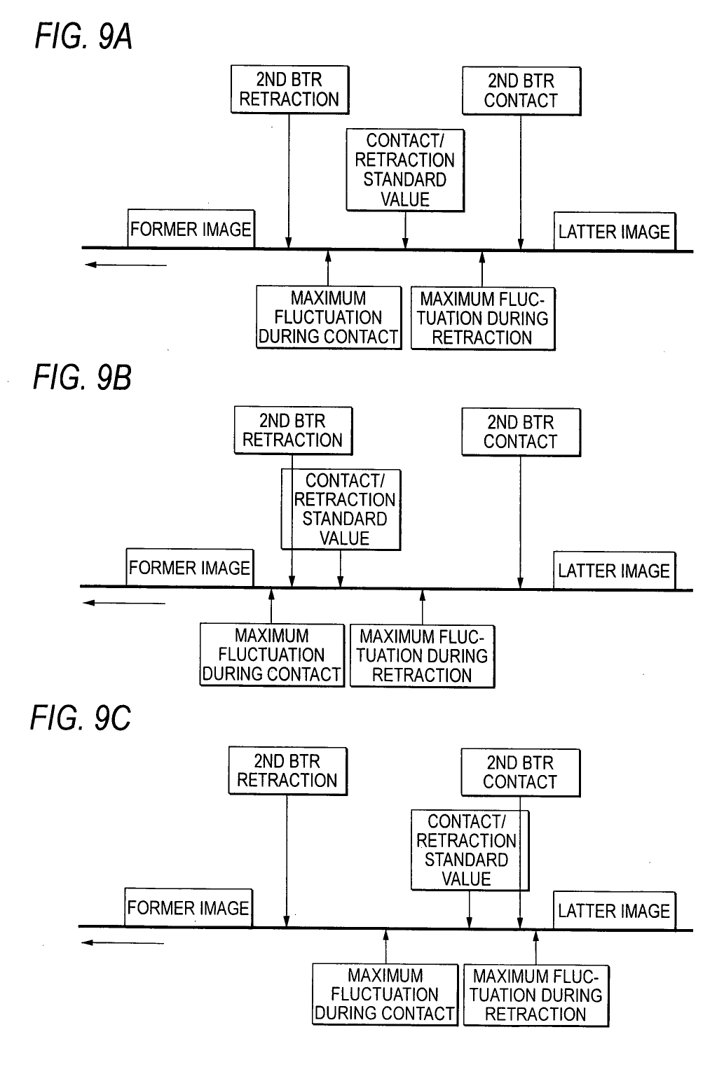

The standard value is an aimed position where fluctuations in design are considered (FIG. 9A). The aimed position is a position where even the maximum fluctuation during the contact and the maximum fluctuation during the retraction do not interfere with the contact/retraction positions of 2nd BTR. At this time, the maximum fluctuations during the contact and the retraction may not be equal.

As shown in FIG. 9B, if the standard position is early, the fluctuation of the standard position during the contact interferes with 2nd BTR retraction position, thereby a contact line is transferred to 2nd BTR, then the line becomes dirt on a back side at the next print.

As shown in FIG. 9C, if the standard position is late, the fluctuation of the standard position during the retraction interferes with 2nd BTR contact position, thereby a retraction line is transferred to 2nd BTR, then the line becomes dirt on a back side at the next print.

FIG. 6B is a diagram showing a contact position 605 which is shifted from the ideal contact position 603 by a specified value C₀. FIG. 6C shows a case where a contact line 606 is formed which is produced when the blade 110a is brought into contact with the transfer belt 106 at the contact position 605 which is shifted by the specified value C₀. As this occurs, the position detection mark 121a on the transfer belt 106 is read by the mark detection sensor 121, and an end portion of a toner image of the contact line 606 on the transfer belt 106 is read by the toner sensor 111. Thereafter, a measured value C₁ is calculated from information read by the mark detection sensor 121 and the toner sensor 111. In this case, since the calculated value C1 indicates that the contact position remains at the ideal position of the blade 110a, no adjustment in position is carried out.

On the other hand, FIG. 6D shows a case where the contact position of the blade 110a lies in a contact position 607 which deviates from the ideal contact position 603. Then, the blade 110a is brought into contact with the transfer sheet 106 at a contact position 608 which is caused to deviate by the specified value C₀ from the deviating contact position 607. FIG. 6E shows a case where a contact ling 609 is formed which is produced when the blade 110a is brought into contact with the transfer belt 106 at the contact position 608 which is caused to deviate by the specified value C₀ from the deviating contact position 607. As this occurs, the position detection mark 121a on the transfer belt 106 is read by the mark detection sensor 121, and an end portion of a toner image of the contact line 609 on the transfer belt 106 is read by the toner sensor 111. Thereafter, a measured value C₁ is calculated from information read by the mark detection sensor 121 and the toner sensor 111. Then a correction value C_{X} is obtained.

The correction value C_{X} is obtained by C_{X}=L−C₁−C₀. An adjustment value A is obtained using the correction value C_{X} obtained from the operation. The adjustment value A is obtained by A=C₀+C_{X}. Then, by adjusting the contact position by a quantity equivalent to the adjustment value A which is obtained from the operation above, the contact position of the blade 110a can be adjusted to the ideal contact position. Note that in the case of the ideal contact position 603 in FIG. 6B, since the correction value C_{X}=L−C₁−C₀=0, no adjustment is carried out. Next, in an adjustment method for the retraction position, while when adjusting the contact position, the contact position is shifted towards the halftone 601 by the quantity equivalent to the specified value C₀, the retraction position is shifted towards the halftone 602 by the quantity equivalent to the specified value C₀, and an end portion of a toner image of a retraction line is read by the toner sensor 111, so as to obtain a correction value C_{X} for adjustment of the retraction position.

Note that while in the position adjustment methods, the end portions of the toner images of the contact line and the retraction line of the blade 110a are read by the toner sensor 111 so as to obtain the correction value C_{X} for adjustment of the positions, a configuration may be adopted in which the blade 110a is set to be brought into contact with the transfer belt 106 on the halftone 601 and be retracted therefrom on the halftone 602 by increasing the specified value C₀ so as to clean the half tones 601 and 602, and end portions of toner images of the half tones 601 and 602 which are partially cleaned are read by the toner sensor 111 so as to obtain a correction value C_{X}. In addition, as to a timing when the position adjustment by the position adjustment mode is executed, the position adjustment may be executed every time a power supply for the color printer 100 is switched on or every time hundreds of prints are printed, or be executed by changing the setting in function of the color printer 100. In addition, the end portions of the toner images may be made to be read not by the toner sensor 111 but by the mark detection sensor 121.

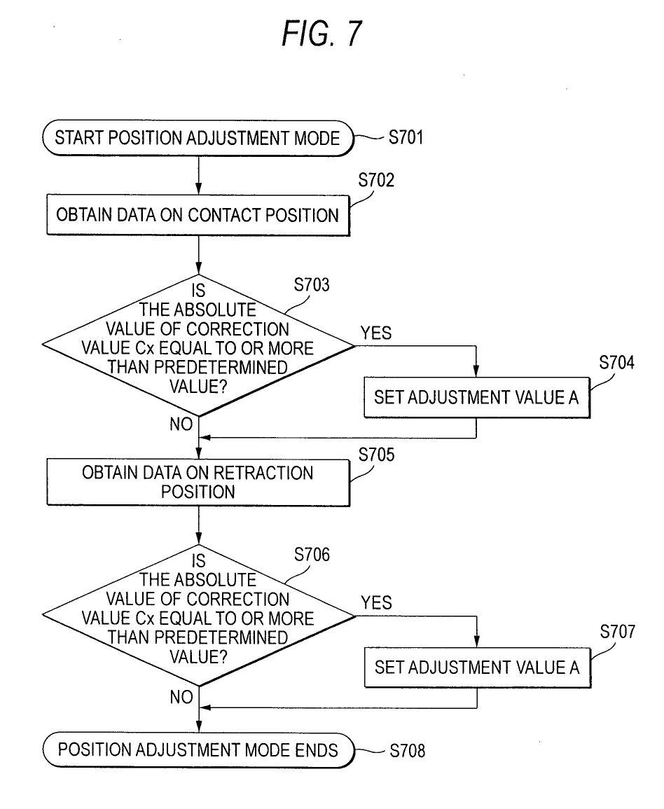

FIG. 7 is a flowchart showing an example of a processing procedure of the position adjustment mode of the image forming apparatus which is equipped with the configuration shown in FIG. 1. An operation program for executing the processing procedure shown in the flowchart in FIG. 7 is stored in the ROM 202 shown in FIG. 2.

In this embodiment, when the position adjustment mode is started (step S701), data on the contact position is obtained (step S702). After step S702, a process is executed for determining whether or not the absolute value of the correction value Cₓ is equal to or more than a predetermined value (step S703). A value obtained in advance based on a predetermined contact position and a necessary data quantity that is necessary to realize the contact position and stored in the ROM 202 is used for a value based on which the determination is made.

In this determination, a correction value C_{X} is calculated by an operation of corrected value C_{X}=standard value L−measured value C₁−specified value C₀, and the value stored in the ROM 202 is compared with the absolute value of the correction value C_{X} to determine whether or not the absolute value of the correction value C_{X} is equal to or more than the predetermined value. As an example, if the absolute value of the correction value C_{X} before adjustment is equal to or more than 5 mm, the determination in step S703 becomes YES. On the other hand, if the absolute value of the correction value C_{X} before adjustment is less than 5 mm, the determination in step S703 becomes NO.

If the absolute value of the correction value C_{X} of the contact position is equal to or more than the predetermined value, the determination in step S703 becomes YES, and the flow proceeds to step S704. In step S704, a process for setting the contact position to the adjustment value A is performed. In the process for setting the contact position to the adjustment value A, an adjustment value A is calculated by operation of adjustment value A=specified value C₀+correction value C_{X}, and the contact position is set to the adjustment value so calculated. Thereafter, the flow proceeds to step S705. On the other hand, if the absolute value of the correction value C_{X} of the contact position is less than the predetermined value, the determination in step S703 becomes NO, and the flow proceeds to step S705 without performing the adjustment of the contact position.

Next, in step S705, data on the retraction position is obtained, and after step S705, a process is performed for determining whether or not the absolute value of the correction value Cₓ of the retraction position is equal to or more than the predetermined value (step S706). Then, if the determination in step S706 is YES, setting the value of the retraction position to the adjustment value A is performed (step S707), whereby the position adjustment mode ends (step S708). On the other hand, if the determination in step S706 is NO, the position adjustment mode ends without performing the adjustment of the retraction position (step S708).

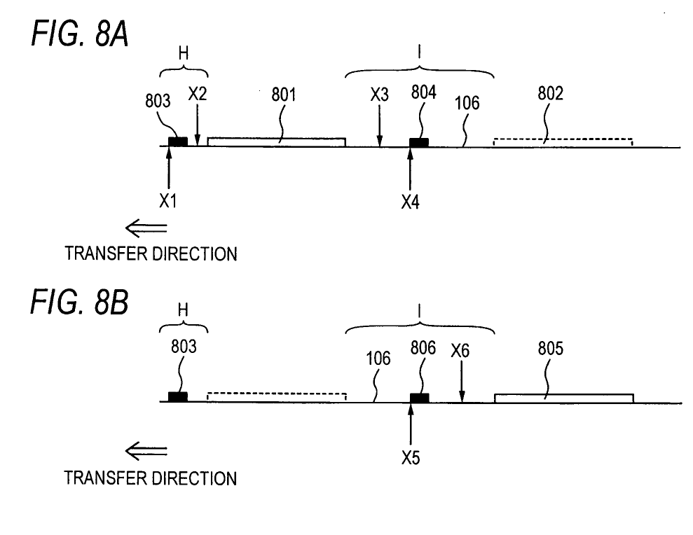

FIGS. 8A and 8B show diagrams which illustrate an example of an operation to be performed after the contact and retraction positions of the blade 110a have been adjusted. FIGS. 8A and 8B show a case where two toner images can be transferred on to the transfer belt 106 and shows contact and retraction positions of the blade 110a and the secondary transfer roller 126a in a non-image area H and a non-image area I on an Nth turn and an N+1th turn of the transfer belt 106.

In this embodiment, timings when the secondary transfer roller 126a moves into contact with and apart from the transfer belt 106 are set based on the adjustment of the contact and retraction positions of the blade 110a in such a manner that a contact (at a position X2) of the secondary transfer roller 126a, a retraction (at a position X3) of the secondary transfer roller 126a, a contact (at a position X1) of the blade 110a, a retraction (at a position X4) of the blade 110a, a contact (at a position X6) of the secondary transfer roller 126a and a contact (at a position X5) of the blade 110a occur in the order of passage of time in the non-image area H and the non-image area I on the transfer belt 106.

When a primary image 801 is secondarily transferred on to a printing sheet, the illustration thereof being omitted, on an Nth turn shown in FIG. 8A, the secondary transfer roller 126a is brought into contact with the transfer belt 106 at the position X2 in the non-image area H so as to transfer the primary image 801 on to a printing sheet, whereafter the secondary transfer roller 126a is retracted from the transfer belt 106 at the position X3 on the non-image area I. Then, in order to scrape off toner of the primary image 801 which remains on the transfer belt 106 without having been secondarily transferred on to the printing sheet, the blade 110a is brought into contact with the transfer belt 106 at the position X1 on the non-image area H so as to clean the transfer belt 106, and after the transfer belt 106 has been so cleaned, the blade 110a is retracted from the transfer belt 106 at the position X4 on the non-image are I. As this occurs, a contact line 803 is formed in the position X1, and a retraction ling 804 is formed in the position X4. Here, the reason the blade 110a is retracted from the transfer belt 106 in the non-image area I which lies right before a secondary image transfer position 802 is to avoid a risk that toner images to the third color which are formed in the secondary image transfer position 802 are scraped off.

When a secondary image 805, in which images of all the four colors have been completely transferred, is secondarily transferred on to a printing sheet on the N+1th turn of the transfer belt 106 shown in FIG. 8A, the illustration thereof being omitted, the secondary transfer roller 126a is brought into contact with the transfer belt 106 at the position X6 on the non-image area I, so that the secondary image 805 is transferred on to the printing sheet. Then, the blade 110a is brought into contact with the transfer belt 106 at the position X5 in the non-image area I with a view to scraping off toner of the secondary image 805 which remains on the transfer belt 106 without having secondarily been transferred on to the printing sheet, so as to clean the surface of the transfer belt 106. As this occurs, since the contact and retraction positions of the blade 110a are adjusted, the contact line 806 is formed in the position X5, and the retraction line 804 that is formed on the Nth turn and the contact line 806 that is formed on the N+1th turn of the transfer belt 106 come to be formed in substantially the identical positions on the transfer belt 106. In addition, since the timings when the secondary transfer roller 126a moves into contact with and apart from the transfer belt 106 are set based on the adjustment of the contact and retraction positions of the blade 110a, there occurs no risk that the secondary transfer roller 126a is soiled by toner of the contact line and the retraction line.

Namely, since the contact and retraction positions of the blade 110a are adjusted properly, there can still be provided a construction in which the secondary transfer roller 126a is made difficult to be soiled even though the width of the non-image area is narrowed. In addition, even though there occurs a deviation in the contact and retraction positions of the blade 110a due to replacement of components of the cleaning apparatus, the relevant positions can be adjusted properly by the execution of the position adjustment mode.

### (2) Second Embodiment

While in the first embodiment, the position adjustment is performed by utilizing the mark detection sensor 121 for reading the position detection mark 121a and the toner sensor 111 for reading the condition of toner on the transfer belt 106 which are shown in FIG. 1, the position adjustment may be performed by utilizing an additional sensor, which is separate from the mark detection sensor 121 and the toner sensor 111.

### (3) Third Embodiment

While in the first embodiment, the example of the image forming apparatus is described which makes use of the invention which is applied to the cleaning apparatus 110 shown in FIG. 1, there may be provided an image forming apparatus in which the contact position or retraction position of the blade is adjusted by utilizing an additional sensor while applying the invention to the light-sensitive material drum cleaning apparatus 105 which is in proximity to the light-sensitive material drum 103 shown in FIG. 1.

In the description of the embodiments, while the program for executing the blade position adjustment mode and programs for executing the other operations which are described in the specification are stored in the ROM disposed within the apparatus, those programs can be provided while being stored in an appropriate storage medium such as another semi-conductor memory, an optical disk storage unit, a magnetic disk storage unit or a magneto-optical disk storage unit.

The invention can be applied to an image forming apparatus such as a color printer, a Fax, a color photocopier and a composite machine thereof.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An image holding element cleaning apparatus comprising:
an image holding element;
an image holding element cleaning unit that touches and detaches from the image holding element and that cleans the image holding element when the image holding element cleaning unit touches the image holding element;
a detection unit that detects at least one of a position of the image holding element cleaning unit on the image holding element when the image holding element cleaning unit touches the image holding element, and a position of the image holding element cleaning unit on the image holding element when the image holding element cleaning unit detaches from the image holding element; and
an adjusting unit that adjusts at least one of an operation timing of touching and an operation timing of detaching based on a result of a detection by the detection unit, the operation timing of touching being the timing when the image holding element cleaning unit touches the image holding element, and the operation timing of detaching being the timing when the image holding element cleaning unit detaches from the image holding element.

2. The image holding element cleaning apparatus according to claim 1,
wherein an adjustment of the operation timing by the adjusting unit is carried out so that the image holding element cleaning unit is allowed to touch and detach from the image holding element in substantially the same position on the image holding element.

3. The image holding element cleaning apparatus according to claim 1,
wherein the detection unit detects an end portion of a cleaned object held on a surface of the image holding element.

4. The image holding element cleaning apparatus according to claim 1,
wherein the detection unit is an image density measuring unit that measures a density of an image on the image holding element.

5. The image holding element cleaning apparatus according to claim 1,
wherein the detection unit is a transfer direction position detection unit that detects a position of the image holding element in a transfer direction.

6. An image holding element cleaning apparatus comprising:
an image holding element;
an image holding element cleaning unit that touches and detaches from the image holding element and that cleans the image holding element when the image holding element cleaning unit touches the image holding element;
a generation unit that generates an image on the image holding element;
a detection unit that detects an end portion of a toner image formed at the time when the image holding element cleaning unit touches or detaches from the image holding element, the image holding element cleaning unit touching or detaching from the image holding element, so as to detect an end portion of the toner image formed on the image holding element to thereby detect a position of the image holding element cleaning unit on the image holding element when the image holding element cleaning unit touches or detaches from the image holding element; and
an adjusting unit that adjusts at least one of an operation timing of toughing and an operation timing of detaching based on a result of a detection by the detection unit, the operation timing of touching being the timing when the image holding element cleaning unit touches the image holding element, and the operation timing of detaching being the timing when the image holding element cleaning unit detaches from the image holding element.

7. The image holding element cleaning apparatus according to claim 6,
wherein at least one of an operation timing of touching and an operation timing of detaching of the image holding element cleaning unit is made to deviate in time from an ideal operation timing of the image holding element cleaning unit when the image holding element cleaning unit touches or detaches from the image holding element by a predetermined period of time, the operation timing of touching being the timing when the image holding element cleaning unit touches the image holding element, and the operation timing of detaching being the timing when the image holding element cleaning unit detaches from the image holding element during a detection of the position thereof, so as to obtain at least one of an operation timing of touching and an operation timing of detaching of the image holding element cleaning unit from the predetermined period of time and an obtained position detection result.

8. An image forming apparatus comprising:
an image holding element cleaning apparatus according to claim 1; and
an image transfer unit that transfers an image on an image holding element onto a recording material,
the image transfer unit having a transfer member that touches the image holding element.
